(19) United States
(12) Patent Application Publication
(10) Pub. No.: US 2019/0324347 A1
(43) Pub. Date: Oct. 24, 2019

(54) ACOUSTIC IMAGING SYSTEMS HAVING SOUND FORMING LENSES AND SOUND AMPLITUDE DETECTORS AND ASSOCIATED METHODS

(71) Applicant: Duke University, Durham, NC (US)

(72) Inventors: Steven Cummer, Durham, NC (US); Yangbo Xie, Durham, NC (US)

(21) Appl. No.: 16/387,085

(22) Filed: Apr. 17, 2019

Related U.S. Application Data
(60) Provisional application No. 62/659,314, filed on Apr. 18, 2018.

(51) Int. Cl. G02F 1/335; G02B 1/00; G02B 6/12; G02F 1/11; G02B 3/00; H04R 1/40

(52) U.S. Cl. CPC G02F 1/335; G02B 1/002; H04R 1/40; G02F 1/113; G02B 3/0087; G02B 6/12004

(57) ABSTRACT

Acoustic imaging systems having sound forming lenses and sound amplitude detectors and associated methods are disclosed herein. According to an aspect, an acoustic imaging system includes a sound forming lens configured to focus sound waves received from a plurality of directions onto respective predetermined areas. The acoustic imaging system also includes sound amplitude detectors positioned to receive the focused sound waves at the predetermined areas and to output signals indicative of the directions of receipt of the sound waves by the sound forming lens.

### CROSS REFERENCE TO RELATED APPLICATION

This application claims priority to U.S. Provisional Patent Application No. 62/659,314, filed Apr. 18, 2018, and titled COMPOSITIONS, SYSTEMS, AND METHODS FOR ACOUSTIC IMAGING WITH METAMATERIAL LUNEBURG LENSES, the content of which is incorporated herein by reference in its entirety.

### FEDERALLY SPONSORED RESEARCH OR DEVELOPMENT

This invention was made with government support under Federal Grant Nos. N00014-13-1-0631 and 1641084 awarded by the Office of Naval Research and National Science Foundation (NSF). The government has certain rights to this invention.

### TECHNICAL FIELD

The presently disclosed subject matter relates generally to acoustic imaging. Particularly, the presently disclosed subject matter relates to acoustic imaging systems having sound forming lenses and sound amplitude detectors and associated methods.

### BACKGROUND

Ultrasonic sensors and systems have been used in a variety of applications to enable a better understanding a surrounding environment. For example, such sensors have been used for driver assistance with automobile parking and steering, for distance measurement, for detection of cracks and damage in structures and objects, for medical diagnostic imaging, and for detection of moving objects, among many others. Ultrasound is an acoustic wave with a very high frequency, beyond human hearing.

Ultrasound has several characteristics which make it so useful and that have led to its use in many applications. For example, it is inaudible to humans and therefore undetectable by the user. Also, for example, ultrasound waves can be produced with high directivity. Also, they have a lower propagation speed than light or radio waves. The fact that ultrasound is inaudible to human ears is an important factor in ultrasound applications. For example, a car parking sensor system generates sound pressure of more than 100 dB to ensure clear reception. This is the equivalent of the audible sound pressure experienced when standing close to a jet engine. Ultrasound's high frequency (short wavelength) enables narrow directivity, similar to its radio wave equivalent, microwaves. This characteristic is used in kidney stone treatments, where ultrasound emitted from outside the body is focused on the stone to break it down. Since the energy level is low, it does not harm the body.

Because ultrasound is a vibration of matter, it can also be used to examine the characteristics of that matter. Ultrasonic diagnosis uses this feature to detect and visualize the variance in reflectance and transmittance corresponding to the water content and density of the matter in the medium, for example an organ in your body.

In view of the advantages and wide variety of applications of ultrasonic sensors and systems, there is a continuing need for improved systems and methods for acoustic imaging.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a block diagram of an acoustic imaging system in accordance with embodiments of the present disclosure;

FIGS. 2-4C illustrate different views of an example Luneburg lens for use as a sound forming lens in an acoustic imaging system in accordance with embodiments of the present disclosure;

FIG. 5 is a graph with inset 3D-crosses for a Luneburg lens with varying geometric coefficient a₀ to read to a range of refractive index;

FIG. 6 is a refractive index profile of a 40 kHz Luneburg lens;

FIG. 7 is an image of a 2.5D sample for 40 kHz airborne ultrasound;

FIG. 8 is an image of a full 3D sample lens for 8 kHz airborne sound;

FIG. 9 is a plan diagram of an experimental setup where a single ultrasonic source is placed on the right-hand side of the lens;

FIG. 10 is a graph showing the comparison between the measured and the simulated pressure amplitude and phase along the focal curve for a single ultrasonic source in coordinate (35 mm, 0 mm);

FIG. 11 is a graph showing the comparison between the measured and the simulated pressure amplitude and phase along the focal curve for a single ultrasonic source in coordinate (30 mm, 10 mm);

FIG. 12 is a graph showing the comparison between the measured and the simulated pressure amplitude and phase along the focal curve for a single ultrasonic source in coordinate 30 mm, −20 mm);

FIG. 13 is a plan diagram of an experimental setup with a single ultrasonic source placed behind a sound hard wall with two 1 mm diameter holes at coordinate (40 mm, −10 mm) and (40 mm, 10 mm) respectively;

FIG. 14 is a graph showing the comparison between the measured and the simulated pressure amplitude and phase along the focal curve;

FIG. 15 is an image of an experimental setup of ultrasonic imaging equipment used for experiments described herein;

FIG. 16 is a diagram of an example workflow of an example GRIPP method in accordance with embodiments of the present disclosure;

FIG. 17 includes a diagram showing dimensions of an example 3D-cross gradient index unit cell, and a table including parameters for the employed library of the gradient index unit cell;

FIG. 18A is an image showing an ideal GRIN lens (continuous refractive index and unity impedance);

FIG. 18B is an image of a GRIN lens with real 3D-cross structures; and

FIG. 18C is a zoomed-in top-down view of the geometry of a GRIN lens.

### SUMMARY

The presently disclosed subject matter includes acoustic imaging systems having sound forming lenses and sound amplitude detectors and associated methods. According to an aspect, an acoustic imaging system includes a sound forming lens configured to focus sound waves received from a plurality of directions onto respective predetermined areas. The acoustic imaging system also includes sound amplitude detectors positioned to receive the focused sound waves at the predetermined areas and to output signals indicative of the directions of receipt of the sound waves by the sound forming lens.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a range is stated as between 1%-50%, it is intended that values such as between 2%-40%, 10%-30%, or 1%-3%, etc. are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

As referred to herein, a “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present disclosure. A computing device can also include any type of conventional computer, for example, a laptop computer or a tablet computer. A typical mobile computing device is a wireless data access-enabled device (e.g., an iPHONE® smart phone, a NEXUS ONE™ smart phone, an iPAD® device, smart watch, or the like) that is capable of sending and receiving data in a wireless manner using protocols like the Internet Protocol, or IP, and the wireless application protocol, or WAP. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. Bluetooth. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

As referred to herein, a “sound forming lens” may refer to any suitable lens or component operable or configured to focus sound waves. A sound forming lens focuses waves by controlling the speed of the wave differently in different portions of the lens so that the incoming wave propagates in a different desired fashion after exiting the lens. For example, a flat wavefront arriving on the lens from a distant object can be converted by the lens to a spherical wavefront that converges to a single focal point. This can be created by a lens that has a slower wave speed in the center of the lens and a faster wave speed at the edges. This variation in wave speed through the lens can be created by varying the thickness of the lens, as in a traditional optical lens with curved surfaces. Such a lens will typically be made from a homogeneous material (i.e., with the same properties everywhere). The variation in wave speed through the lens can also be created by an inhomogeneous material (i.e., with properties that change with position) that has slower sound speed in some portions of the lens and faster sound speed in others. Such a variable sound speed lens is also called a gradient refractive index (GRIN) lens. A GRIN lens may have curved surfaces or it might have flat surfaces, depending on how it is designed. An example of a sound forming lens is a Luneburg lens, which is a spherically symmetric GRIN lens. A Luneburg lens's refractive index n decreases radially from its center to its outer surface. A Luneburg lens is a specific implementation of a gradient index lens with curved surfaces. A 3D Luneburg is spherical or nearly spherical in shape, and a 2D Luneburg lens is cylindrical or nearly cylindrical in shape. Other shapes may be used in the case that the internal material parameters are suitable. The lens may be made of silicone rubber, plastic, metal, or any other suitable material that can be used to control the speed of sound wave propagation. Further, the sound forming lens may be a metamaterial gradient index lens made of an inhomogeneous structured metamaterial wherein changes in the interior structure deliver different sound propagation speeds in different portions of the lens. Other types of sound forming lenses include Sound waves may be received by the lens from a gas, a solid, a fluid, or other material.

As referred to herein, a “sound amplitude detector” should be broadly construed. A sound amplitude detector is any device that responds to mechanical vibrations of a solid, fluid, or gas material and produces an electrical or other signal in proportion to the amplitude of that vibration. Example detectors include, but are not limited to, microphones, hydrophones, vibration detectors, and the like. The signal produced by the detector can be delivered to a display device to visually illustrate the amplitude of the sound or vibration detected. The signal produced by the detector can also be delivered to a computer or computing device that converts the detected amplitudes from a plurality of detectors into an image of the source or sources of the detected sound or vibration.

A sound forming lens in accordance with embodiments of the present disclosure may define an internal channel structure. Small channels in the structure provide a high index of refractions, while large channels provide a lower index of refraction. The cross shapes are one way of creating these channels. Any other way you can make thin channels for sound inside of solid structure would do the same thing.

According to embodiments, a sound forming lens may include multiple cross-shaped structures or nearly cross-shaped structures. The structures may be arranged as a lattice. Further, the structures may each include elongated members that form a cross shape or near cross shape. A width of the elongated members can be set depending on the frequency and wavelength of sound that is desired to be controlled. For example, the width range can be less than approximately 0.1 wavelengths of the controlled sound wave. For example, for 40 kHz ultrasound in air, the wavelength may be approximately 1 centimeter (cm), which means that the internal structure may be smaller than 1 millimeter, approximately. If imaging at 4 kHz is desired, the wavelength is 10 cm, and the internal structure may be set smaller than 1 cm.

In accordance with embodiments, sound forming lens may define internal channels for sound propagation. The structure may be internally connected so that it is a self-supporting structure. Interconnected elongated structures, like intersecting long pillars, are examples structures that can provide this functionality. In another example, small spheres or small cubes, that are interconnected by pillars may provide this functionality. More generally, a sound forming lens in accordance with embodiments of the present disclosure may have an internal solid structure that defines internal sound propagation channels of predetermined cross-sectional area. The structure may be internally connected so that it is self-supporting.

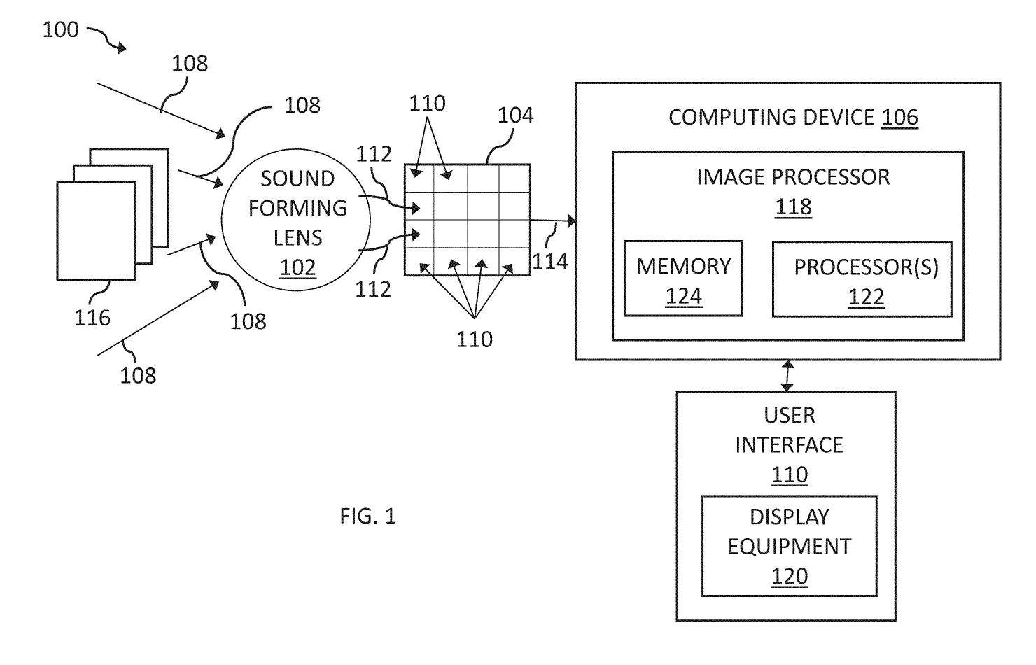

FIG. 1 illustrates a block diagram of an acoustic imaging system 100 in accordance with embodiments of the present disclosure. Referring to FIG. 1, the system 100 includes a sound forming lens 102, an array of sound amplitude detectors 104, and a computing device 106. The sound forming lens 102 may be configured to focus sound waves received from multiple directions (indicated generally by direction arrows 108) onto respective predetermined areas, some of which are indicated by arrows 110. The sound forming lens 102 may have an internal solid structure that defines internal sound propagation channels of predetermined cross-sectional area for focusing the received sound waves. The focused soundwaves are represented by curved arrows 112. The sound forming lens 102 may be a Luneburg lens or any other suitable sound forming lens. As an example, the Luneburg lens may be a GRIN device shaped to have a spherical shape to focus sound from all directions, a cylindrical shape to focus sound from a single flat plane, the like, or substantially one of these shapes, or other shapes designed to focus sound from a desired range of incoming directions.

Sound amplitude detectors 104 may be positioned at the predetermined areas 110 to receive the focused sound waves 112. For example, one or more detectors 104 may be positioned at an area 110 to receive sound waves 112 directed to that area. Each detector 104 may generate electrical output 114 representative of the sound, particularly an amplitude of the sound received by the detector 104. The array of detectors 104 may receive focused sound from the FoV of the sound forming lens 102 to thereby generate output representative of sound received from the FoV.

As an example, sound waves 108 may originate from one or more sources 116. Sounds waves 108 from the source(s) 116 may be directed by the sound forming lens 102 to particular areas 110 where a subset of detectors 104 are located. As a result, the electrical output of this subset of detectors 104 can be processed to indicate a location and/or direction of the source(s) 116. Particularly, the computing device 106 includes an image processor 118 configured to receive the electrical output of the detectors 104 and to control display equipment 120 of a user interface 122 to display a representation of the directions of receipt of the sound waves 108 by the sound forming lens 102, which can be indicative of the location and/or direction of the source(s) 116.

The computing device 106 may be any suitable computer, such as a desktop computer or laptop computer, operatively connected to the detectors for receiving the electrical output 114 of the detectors 104 and for processing the electrical output 114. The image processor 118 may be configured to receive data indicative of the amplitude of the electrical output 114 of the detectors 104. The image processor 118 may also control the display equipment 120 to display a representation of the received data. For example, the display equipment 120 may display a representation of the directions of receipt of the sound waves 108 by the sound forming lens 102. Further, the display equipment 120 may be controlled to display a representation of respective amplitudes of the sound waves 108.

The image processor 118 may include hardware, software, firmware, or combinations thereof. For example, the image processor 118 may include one or more processors 122 and memory 124. A user may use the user interface 110 to control display via the display equipment 120 and settings of the image processor 118.

In accordance with embodiments, a Luneburg lens is disclosed herein for use as a sound forming lens and that provides for scalable and self-supporting metamaterials that focus airborne sound and ultrasonic waves. In experiments, two Luneburg lenses have been fabricated: a 2.5D ultrasonic version for 40 kHz and a 3D version for 8 kHz sound. Imaging performance of the ultrasonic version is experimentally demonstrated.

Luneberg lenses disclosed herein can bend a plane wave of sound to a focal spot on the opposite spherical surface of the lens, which can be a very attractive feature in imaging since the lens maps the direction information directly to the spatial locations of the focuses. As disclosed herein, the focal spot can be located at an array of sound amplitude detectors. Secondly, a Luneberg lens has spherical symmetry (or cylindrical symmetry for the two-dimensional case), which brings in advantages of minimal spherical aberration and a wide FoV (in principle even a full solid-angular coverage can be achieved if the sensor is transparent to the incoming wave). Also, a Luneburg lens shares many advantages typical for GRIN devices: refractive index profiles are non-singular; non-resonant structures are needed; and the operating bandwidths are usually larger compared to the diffractive devices that achieve similar functionalities.

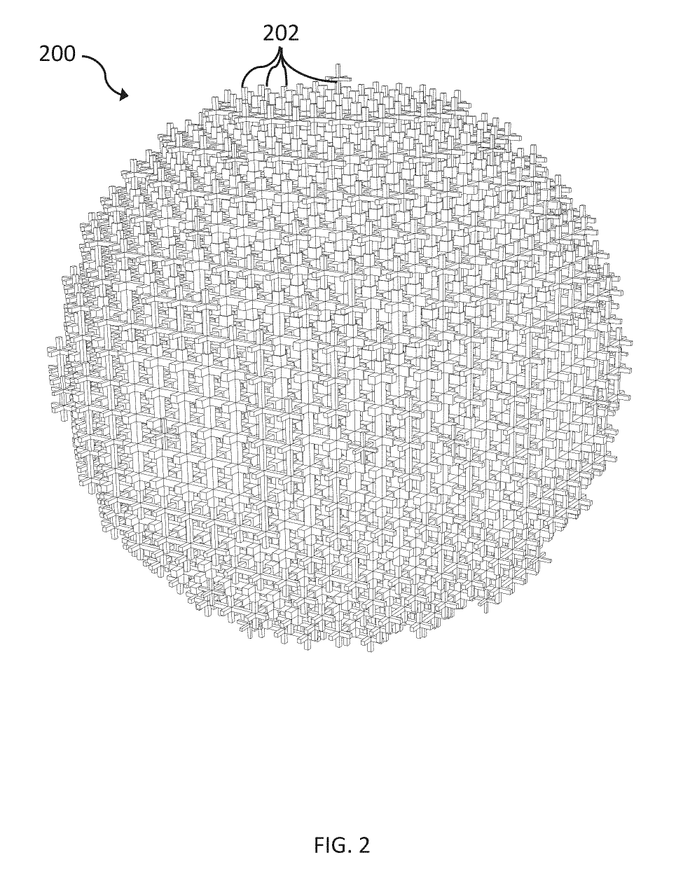

Luneburg lenses for use as sound forming lenses disclosed herein may be a series of 3D cross-shaped metamaterial structures that are stacked layer-by-layer to form a stable lattice. FIGS. 2-4C illustrate different views of an example Luneburg lens 200 for use as a sound forming lens in an acoustic imaging system in accordance with embodiments of the present disclosure. The Luneburg lens 200 in this example is spherically shaped. Referring to FIG. 2, lens 200 is formed of multiple cross-shaped structures 202 that are spaced apart from each other and that are arranged as a lattice by the connection of ends of cross-shaped structures 202 to neighboring structures 202. The internal structure of the lens 200 defines sound propagation channels of predetermined cross-section area. These channels can bend received sound waves to the sound amplitude detectors (e.g., detectors 104 shown in FIG. 1). The sound propagation channels are interconnected interior channels that are bounded by the solid cross-shaped structure. Thicker cross-shaped structure creates narrower sound propagation channels through which the sound propagation speed is slower, while thinner cross-shaped structure creates wider sound propagation channels through which the sound propagation speed is faster. In this manner, the interior structure controls the speed of sound propagation through the lens. FIGS. 2-4C also illustrate the interior sound propagation channels formed in between the solid cross-shaped structure.

FIG. 3 depicts a cross-section view of the lens 200 for the case of a spherical lens that receives sound from all directions. The cross-shaped structure is composed of solid material, and sound propagates through the interior channels bounded by the solid cross-shaped structure. Incoming sound from outside the lens enters and propagates through the interior channels. The solid structure is thicker in the center of the lens and thinner at the edges. This creates smaller channels in the center with slower sound speed, and larger channels at the edges with faster sound speed. This variation in sound speed changes the shape of the incoming sound wave and focuses the incoming sound from a single direction to a single point on the opposite side of the lens. In this way, sound from different directions is focused to different points along the edge of the lens. Sound detected at these different focal points creates an image of the incoming sound.

FIG. 4A depicts a view of a center portion of the lens 200 for the case of a cylindrical lens that receives sound from directions in the plane of the lens, or in a circle surrounding the lens. The cross-shaped structure is composed of solid material, and sound propagates through the interior channels bounded by the solid cross-shaped structure. The solid structure is thicker in the center of the lens and thinner at the edges. This creates smaller channels in the center with slower sound speed, and larger channels at the edges with faster sound speed.

FIG. 4B depicts a front, cross-sectional view the lens, and FIG. 4C depicts a side view of a portion of the lens 200. In the views provided by these figures, some of channels 400 defined by the cross-shaped structures 202 are easier to view, because the entire length of them through the lens 200 is visible.

In experiments, the characterization of the performance of a 2.5D ultrasonic Luneburg lens was demonstrated. Two imaging experiments were implemented to demonstrate its functionalities in imaging: finding the direction of a single source; and resolving multiple sources. The experimental platform is disclosed herein, and the measurement results are presented and compared with the simulation results. The ultrasonic Luneburg lens can be useful for enhancing the sensing performance of existing pulse-echo-based airborne ultrasonic sensors and imaging systems, and the audible embodiment may be used for improving the radiation pattern for speaker systems.

Materials for a Luneburg lens as disclosed herein include solid materials, such as metal and plastics, that have close-to-infinite impedance contrast with air for acoustic waves. Combining high impedance material with air can form composites with finite impedances. By varying the filling ratio of the high impedance material, a range of above-unity refractive index can be achieved. Two-dimensional designs based on such a filling-fraction composite have been successfully demonstrated.

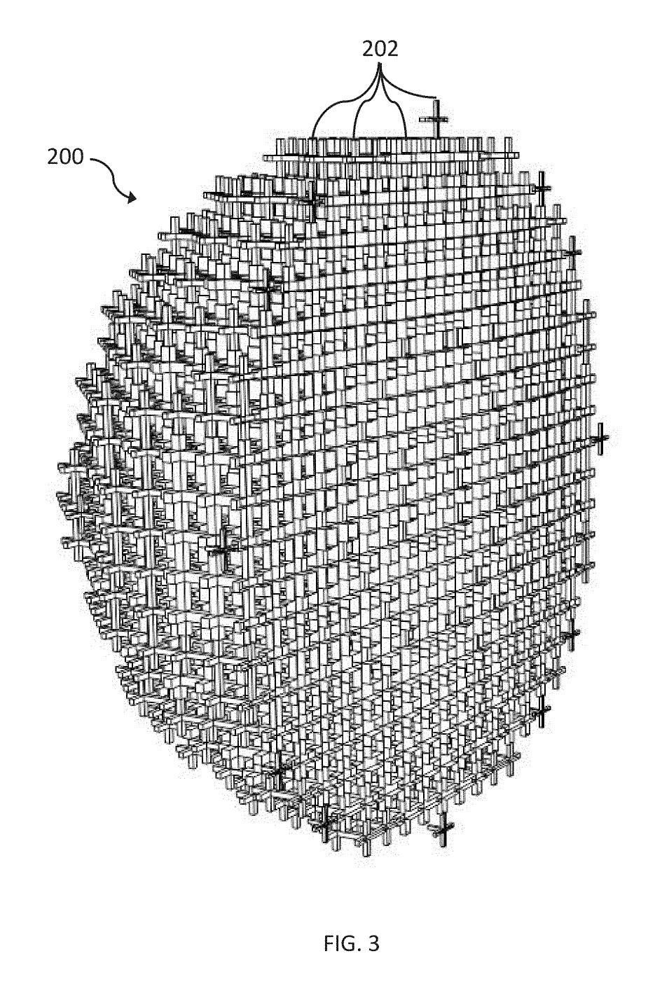

A three-dimensional GRIN device as disclosed herein can be a structure that is self-supporting and mechanically stable for overlaying layers. For example, a series of 3D-cross-shaped metamaterial structures as disclosed herein may be used building blocks for the structure. For example, the structure shown in FIGS. 2-4 may be used. Each 3D-cross with its surrounding air acts as a subwavelength cubic voxel and a 3D array of such voxels form a structurally stable cubic lattice. The family of these metamaterial voxels is illustrated in FIG. 5, which shows a graph with inset 3D-crosses for a Luneburg lens with varying geometric coefficient a₀ to read to a range of refractive index. In the insets, the dimension of a₀D is marked (D is the length of the unit cell, which is 2 mm for the ultrasonic version). By varying the dimensions of the 3D-cross through a geometrical coefficient a₀, a refractive index ranging from 1 to 1.5 can be achieved. Such design has several advantages: 1) the lattice structure can stably build up in a layer-by-layer fashion to form a 3D spatially inhomogeneous device; 2) the cubic unit cells are subwavelength and have isotropic effective wave properties; 3) the design has broader bandwidth than resonant metamaterial structures and the refractive index contrast is relatively constant over about 25% of the central frequency (see SI for more information); and 4) the structures may be directly 3D printable with suitable 3D printer for frequencies up to at least 40 kHz.

A CAD tool, such as a tool disclosed herein and referred to as GRadient Index Pick-and-Place (GRIPP), may be used to map the refractive index profile to the realistic 3D-cross structures and automatically create the structural layout for straightforward 3D printing. GRIPP is a universal design tool for achieving a large range of GRIN devices. This tool may receive the input of the spatial distribution of the refractive index and the preferred unit cell library. Subsequently, the tool may generate a 3D printable structure of the GRIN device. The technical details of GRIPP are described herein.

To demonstrate the design technique applied herein, two acoustic GRIN lenses designed with the above-mentioned unit cell structures and CAD tool are presented. Both GRIN lenses are Luneburg lenses with refractive index that follow the formula

$$n = \sqrt{2 - {( \frac{r}{R} )}^{2}} .$$

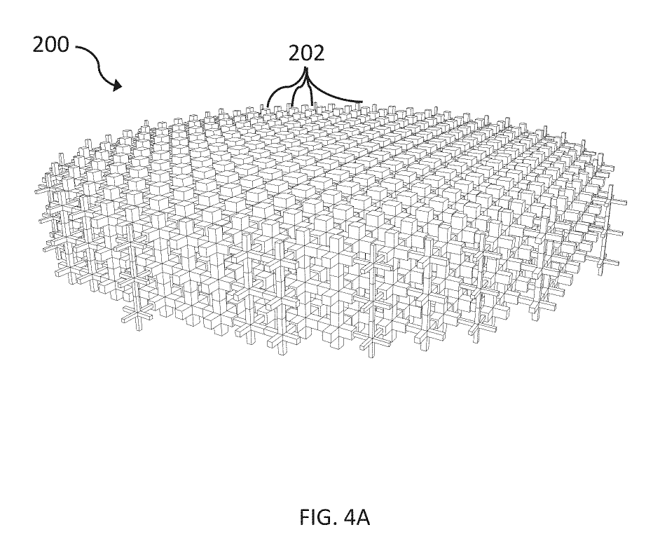

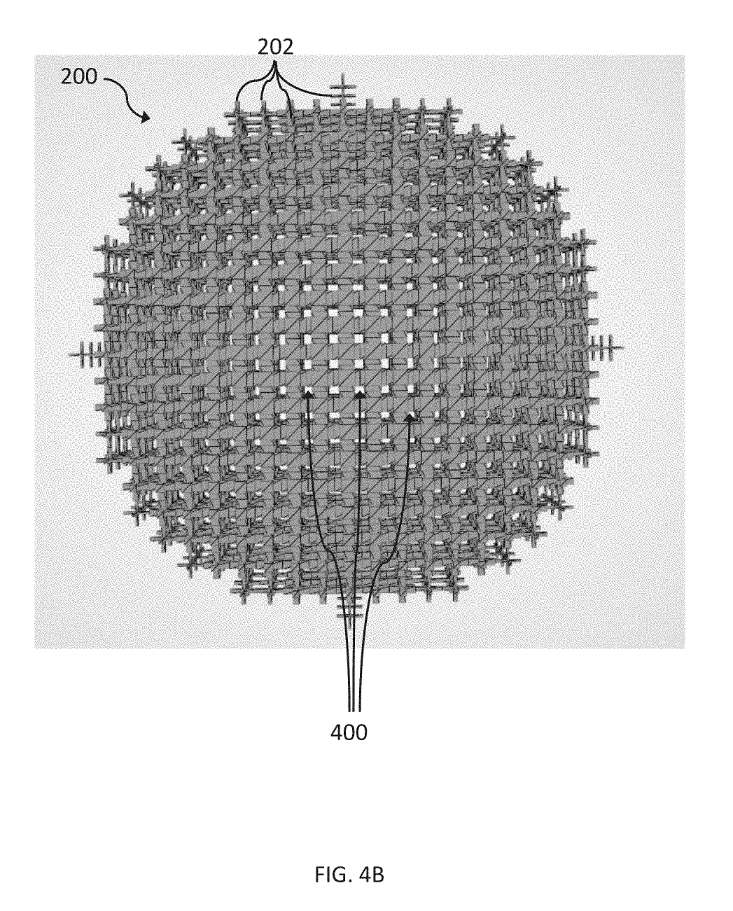

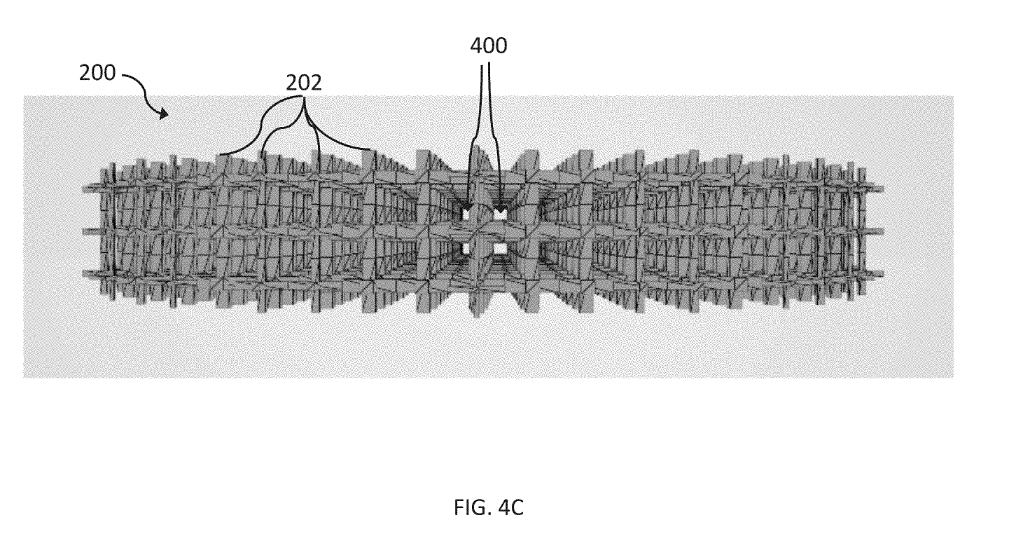

The target index distribution for an ultrasonic 2.5D Luneburg lens is shown in FIG. 6, which shows a refractive index profile of a 40 kHz Luneburg lens. Its spatial inhomogeneity is in its two-dimensional plane and the plane is extruded uniformly by three layers of unit cells in the third dimension. The lens is designed for 40 kHz airborne ultrasound, which may be widely applied for distance ranging and obstacle detection. The unit cell size of this design is 2 mm, which is about 23.3% of the wavelength. The smallest feature (e.g., a hole around the center) of the design is about 760 μm. This ultrasonic sample may be fabricated with a PolyJet 3D printer and is shown in FIG. 7, which is an image of a 2.5D sample for 40 kHz airborne ultrasound. In the sample of FIG. 7, there are three layers of the 3D-cross unit cells along the out-of-plane dimension. The second sample is a 3D Luneburg lens designed for 8 kHz sound, shown in FIG. 8, which is an image of a full 3D sample lens for 8 kHz airborne sound. The unit cell size of this design is 5 mm, which is about 11.7% of the wavelength. Due to the larger volume of this design, PolyJet printing may be implemented with a stereolithography (SLA) printer or other suitable printer. Two hemispheres were independently printed and jointed with an ultraviolet (UV) bonding process.

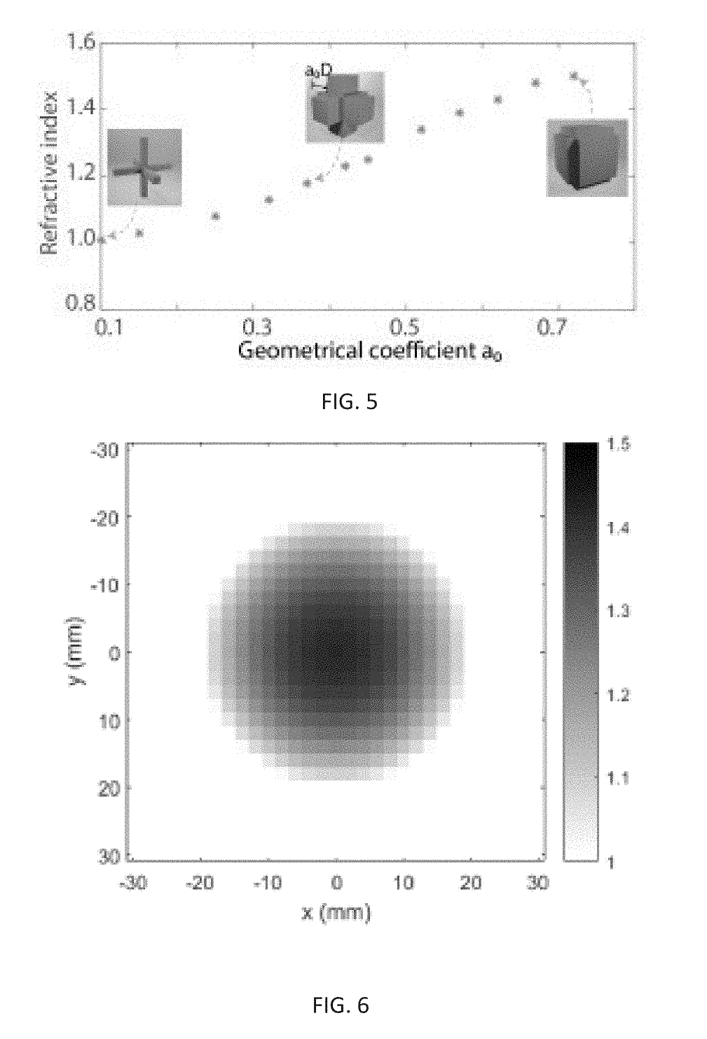

Presented here are experimental characterization of the 40 kHz Luneburg lens. Particularly demonstrated here is that a Luneburg lens can be used for direction finding of the sources, without the need of computational beamforming. FIG. 9 illustrates a plan diagram of an experimental setup where a single ultrasonic source is placed on the right-hand side of the lens. Here, pressure along the semi-circle focal curve with 28 mm radius on the left-hand side of the lens is measured. Referring to FIG. 9, an ultrasonic source is placed on the right side of the lens; on the left side is the semi-circular focal surface (dashed curve). For a point source placed infinitely far away from the lens, the incoming beam is close to plane wave and the focal spot may be formed on the edge of the Luneburg lens. For a source placed at finite distance away from the lens, the focal plane may be finite distance away from the edge of the lens.

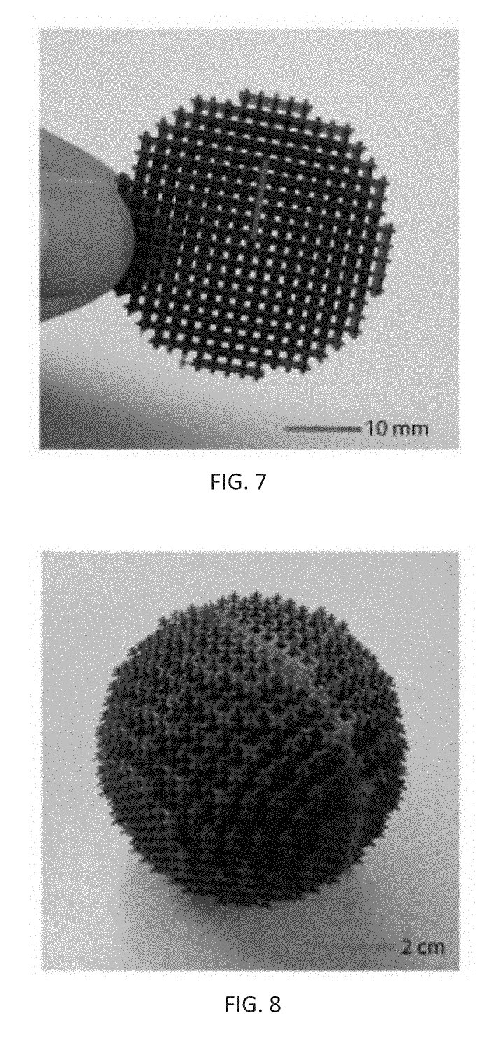

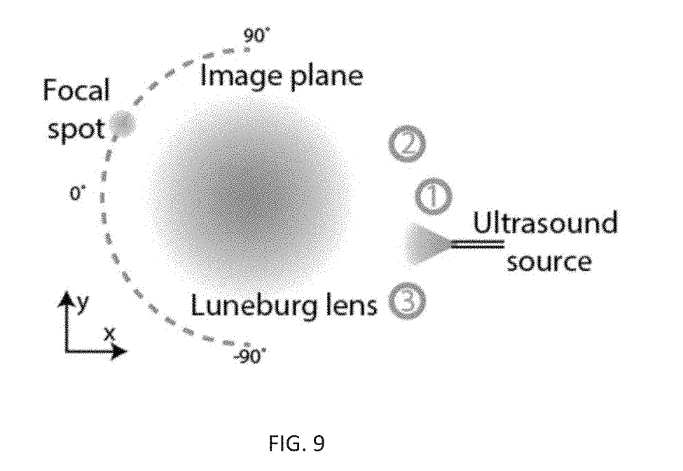

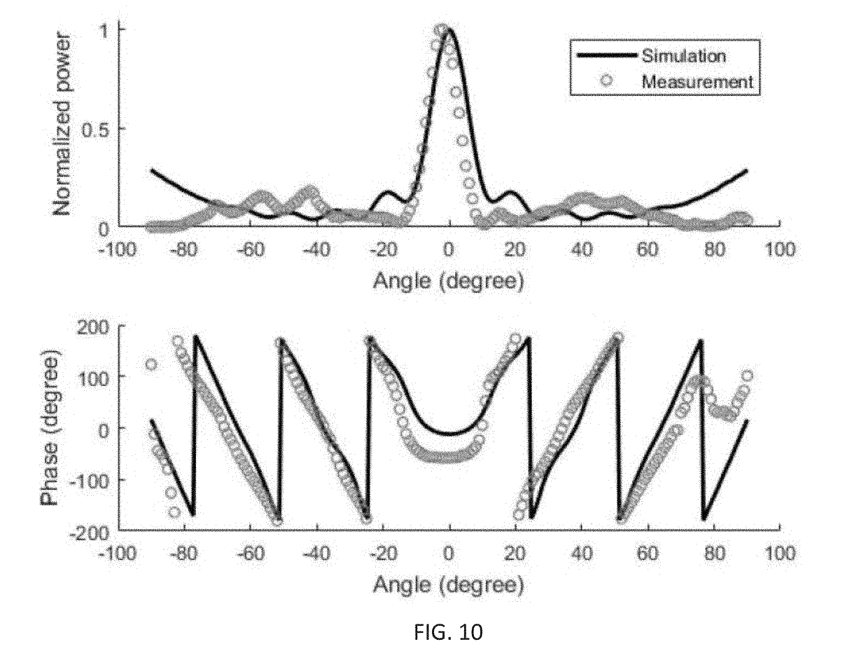

Ideally, an array of sensors may be deployed on the curved focal surface, so the measured amplitude distribution can inform the direction of the source. For the convenience of the experiment, the focal surface was scanned with a single receiver. A variety of source locations were tested and here three representative locations were selected where their images form at about 0, −20 and 40 degrees respectively. The comparison between the measurements and the simulated results were shown in FIGS. 10, 11, and 12. FIG. 10 is a graph showing the comparison between the measured and the simulated pressure amplitude and phase along the focal curve for a single ultrasonice source in coordinate (35 mm, 0 mm). FIG. 11 is a graph showing the comparison between the measured and the simulated pressure amplitude and phase along the focal curve for a single ultrasonic source in coordinate (30 mm, 10 mm). FIG. 12 is a graph showing the comparison between the measured and the simulated pressure amplitude and phase along the focal curve for a single ultrasonic source in coordinate 30 mm, −20 mm). The simulated results were extracted from a commercial finite-element method-based software, COMSOL Multiphysics 5.3 (Pressure Acoustics module). The amplitude distribution along the focal curve clearly shows peaks corresponding to the image of the sources. The measured amplitude and phase have excellent agreement with those extracted from the simulations. The location of the image along the focal curve indicates the source location. As a result, the source direction and the image location have an isomorphic mapping, thus no computation such as beamforming is required to solve the inverse problem of finding the direction of the source.

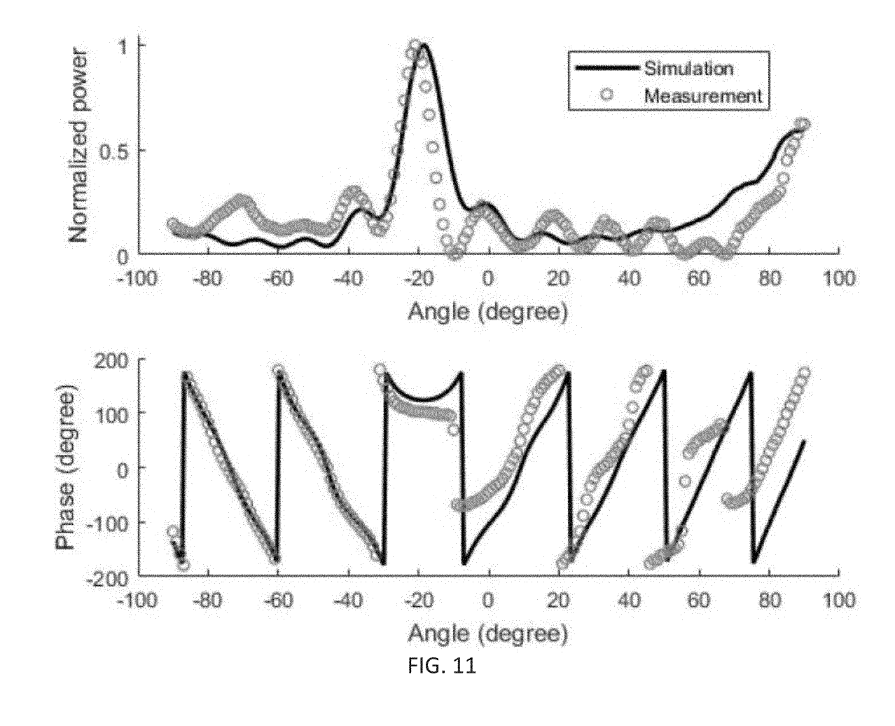

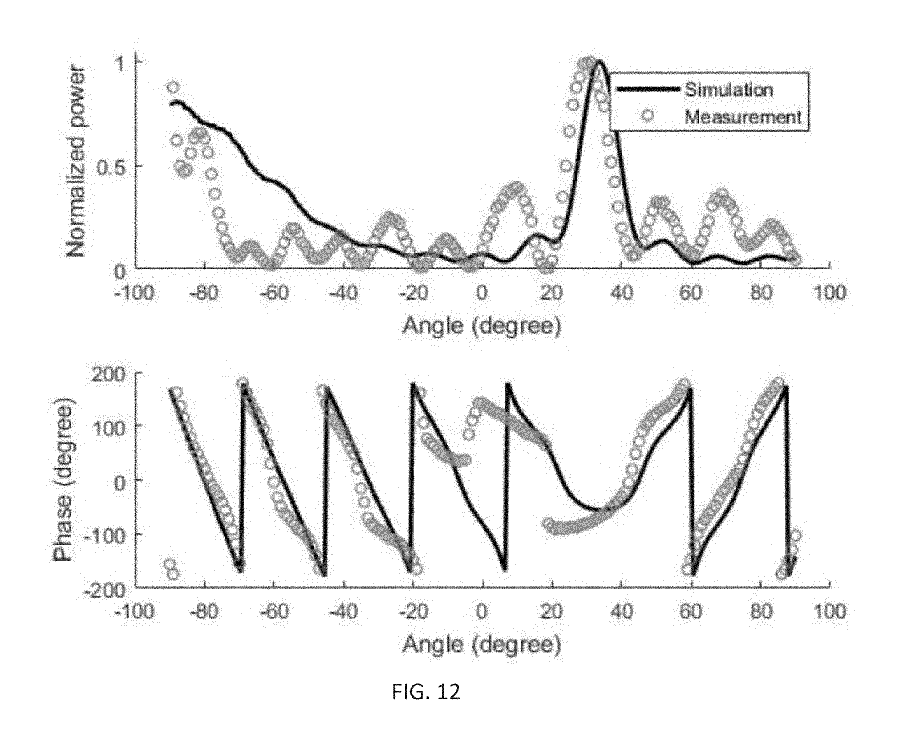

To verify that the Luneburg lens can resolve multiple sources, another experiment was conducted to demonstrate the imaging capability of the Luneburg lens. A sound-hard plate with two circular holes (1 mm diameter) was placed 40 mm away from the center of the lens. An ultrasonic source illuminating the plate forms a pair of sources, as shown in FIG. 13, which illustrates a plan diagram of an experimental setup with a single ultrasonic source placed behind a sound hard wall with two 1 mm diameter holes at coordinate (40 mm, −10 mm) and (40 mm, 10 mm) respectively. The pressure along the semi-circle focal curve on the left-hand side of the lens is measured. When the sound field on the curved focal surface is measured, two sources were clearly resolved, as shown in FIG. 14, which is a graph showing the comparison between the measured and the simulated pressure amplitude and phase along the focal curve. The measurement is in excellent agreement with the prediction from simulation, with the two peaks slightly displaced due to the imperfect alignment of the holes. This imaging experiment demonstrates that such lens can be used not only for direction finding, but also can resolve multiple acoustic sources directly on the focal curve.

A number of applications may be enabled by ultrasound lenses such as the Luneburg lens described above. By shaping the airborne acoustic wavefront, acoustic radiation can be collimated to allow longer propagation distance or be concentrated to an energy hotspot. The design and demonstration of airborne ultrasound lens may impact a variety of sensing applications that utilizes ultrasonic waves (mostly 30 kHz to 200 kHz) that propagate in air. For example, smart vehicles typically equip ultrasonic sonars to sense the environment to assist self-parking or auto pilot. In addition, particle levitation and wireless power transfer for cable-free transmission of energy are emerging applications of airborne ultrasound.

Lens-based acoustic imaging in accordance with embodiments disclosed herein may be advantageous, for example, because they provide low computational complexity. Like focal optical imaging, a lens-based imaging system can form the object-image mapping directly through the lensing effects without the need of computationally intensive parallel channel processing. In some applications, flexible pressure amplitude sensor plane with visual output (e.g., LED array) can be used to directly form a ‘what-you-see-is-what-you-measure’ image on the sensor plane. Another example advantage is the improved image frame rate. Since the sensor only needs to measure the instantaneous amplitude distribution rather than the full acoustic waveform, the frame-rate is no longer restricted by the duration of the probing pulse.

Systems and methods disclosed herein can be extended to design a large range of spatially inhomogeneous GRIN devices, such as transformation acoustics-based wave controlling devices. The GRIN devices based on the proposed method may impact applications in areas such as audio engineering, ultrasound detectors and sensors.

In experiments, a 40 kHz 2D Luneburg lens was fabricated with a Stratasys J750 PolyJet printer. The printed sample was embedded in a jelly-like support material, and a high-pressure water splashing machine was utilized to remove the support material. The 8 kHz 3D Luneburg lens was fabricated with a Form 2 SLA printer. The spherical design was divided into two hemispheres to eliminate the necessity of extensive supporting structures. The two independently printed hemispheres were jointed with a UV bonding process.

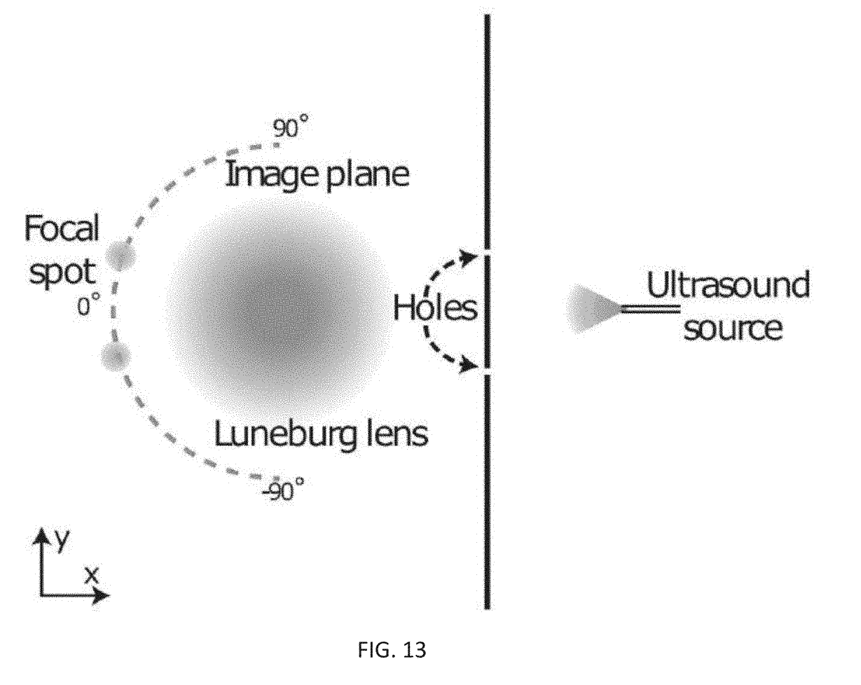

The measurement platform for the lensing experiment disclosed herein is an example of 2D scanning stage. FIG. 15 is an image of an experimental setup of ultrasonic imaging equipment used for experiments described herein. As shown in FIG. 15, an ultrasonic waveguide was fabricated with laser-cut acrylic plates to confine the transmitted ultrasonic wave in a quasi-two-dimensional space. A pair of Murata ultrasound transducers (part number MA40S4S and MA40S4R) were used as the transmitter and the receiver. Two 3D printed tapered waveguiding adapters with glass tubes (about 1 mm diameter) were used to guide the ultrasonic wave from the transmitter into the waveguide, and guide the received wave from the waveguide to the receiver transducer. A LM358-based operational amplifier was used as the pre-amplification system. The pre-amplified signal was transmitted then to and be digitized by the NI PCI-6251 data-acquisition system. A 2D linear stage was programmed to scan the field along the pre-defined trajectory along the focal curve.

In accordance with embodiments, a GRadient Index Pick and Place (GRIPP) tool is a universal computer-aided design (CAD) tool that may be used for generating 3D GRIN acoustic wave controlling devices with scalable and 3D printable structures. A GRIPP may be implemented on a suitable computing device and receive as inputs a spatial distribution of refractive index and a pre-defined library of gradient index unit cells, and outputs a 3D model of GRIN device that is ready to be 3D printed. This tool can enable rapid design and realization of a large variety of 3D GRIN acoustic devices, which can be useful in areas such as speaker system design, airborne ultrasonic sensing, as well as therapeutic ultrasound.

The GRIPP tool may operate in LIVELINK™ for MATLAB environment for the convenience of usage. Initially, an analytic expression of the refractive index profile as well as a library of gradient index unit cells may be fed into the algorithm. Subsequently, the algorithm may automatically discretize the 3D space into a spatial grid with subwavelength grid cells. Subsequently, the toop loops over each grid cell and successively fills it with a unit cell that optimally matches the desired local refractive index. Eventually, the algorithm outputs a 3D model in the form of a STL file that can be directly sent to a 3D printer for fabrication.

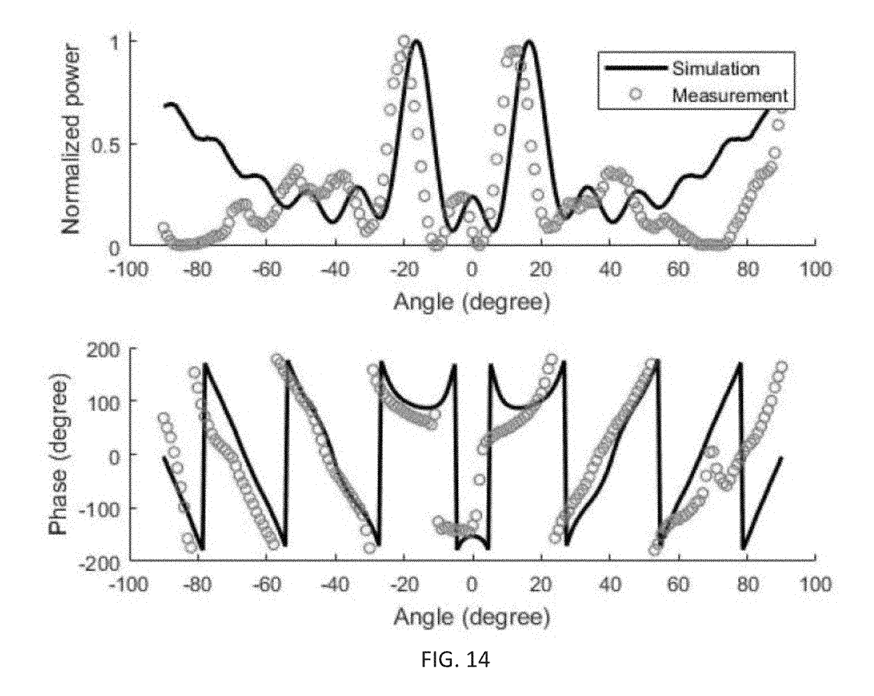

In accordance with embodiments, the GRIPP tool may receive two inputs from the user: an expression of the continuous spatial distribution of refractive index, and a library of gradient index unit cells covering the required range of refractive index. FIG. 16 illustrates a diagram of an example workflow of an example GRIPP method in accordance with embodiments of the present disclosure. As shown in FIG. 16, a continuous function of the 3D profile of the refractive index n(x, y, z) and a library of gradient index unit cells may be fed into the GRIPP. Second, the algorithm may discretize the continuous refractive index profile into spatial grids with a user-defined subwavelength grid cell size. Third, GRIPP may scan through all the grid points, inquire the local refractive index at each grid point, and then search for the unit cell with the closest match of refractive index in the pre-defined library, and then ‘pick-and-place’ the selected unit cell from the library to the grid point. The code may be implemented in MATLAB environment and LIVELINK™ for MATLAB module in used to utilize COMSOL's built-in computer-aided design functionality for the 3D geometry generation and STL file exporting.

Below the GRIPP algorithm is demonstrated with an example of GRIN lens. The refractive index profile of the lens can be expressed as

$$n ( x , y , z ) = 1 + 0.7 {e}^{- \frac{{( x - {x}_{c} )}^{2} + {( y - {y}_{c} )}^{2}}{{r}_{0}^{2}}} \qquad ( 1 )$$

where x_{c}=7.5 mm, y_{c}=2.5 mm and r₀=5 mm. The spatial grid cell was sized to be 2 mm, or about a quarter of wavelength at the interested frequency of 40 kHz. The refractive index profile of this lens is shown in the central inset of FIG. 16.

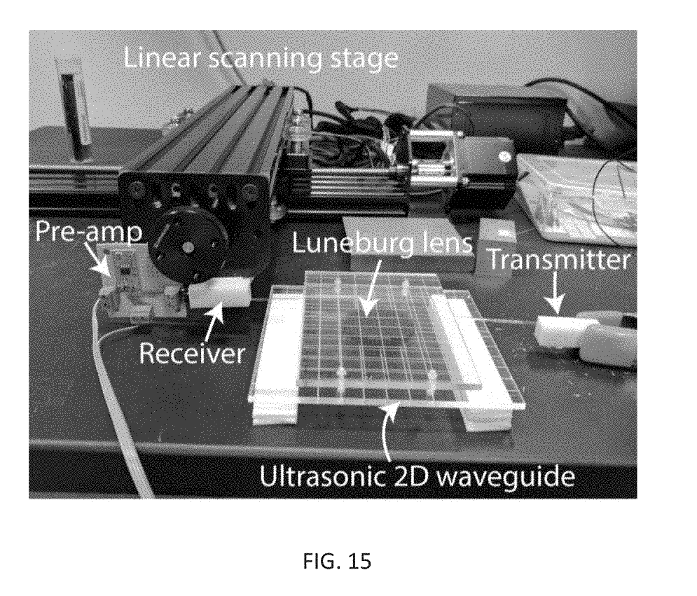

The above refractive index profile requires the refractive index to have a range between 1 and 1.7. Many unit cell designs are possible to achieve this moderate range, here we use as an example a series of designs shaped as 3D-cross. FIG. 17 includes a diagram showing dimensions of an example 3D-cross gradient index unit cell, and a table (Table I) including parameters for the employed library of the gradient index unit cell. As shown in FIG. 17, the 3D-cross unit cell has three orthogonal stubs. In principle, a range of anisotropic refractive index can be achieved with this design with different dimensions along different directions. Since the example of a 2D GRIN lens has only isotropic refractive index profile, the dimensions are simplified, and aₓ=a_{y}=a_{z}=a₀. dₓ=d_{y}=d_{z}=D was also defined, where D is the size of the grid cell, so that each cell is interconnected with its adjacent cells to form a self-supporting lattice. The pre-defined library contains 12 unit cells that covers the range of refractive index between 1 and about 1.77, as shown in Table I in FIG. 17.

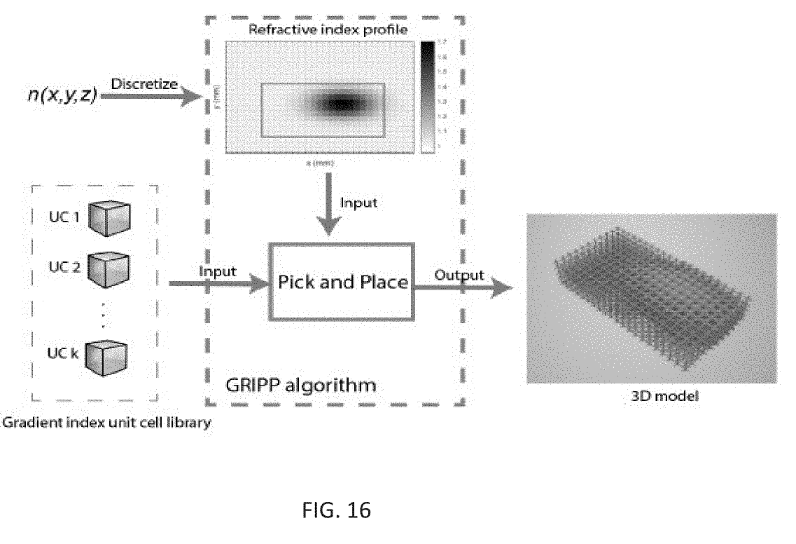

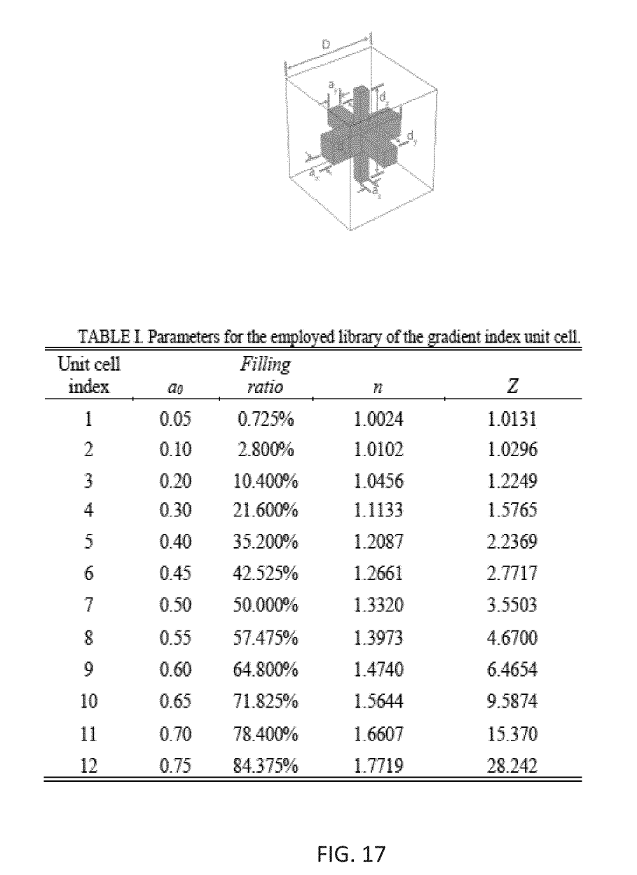

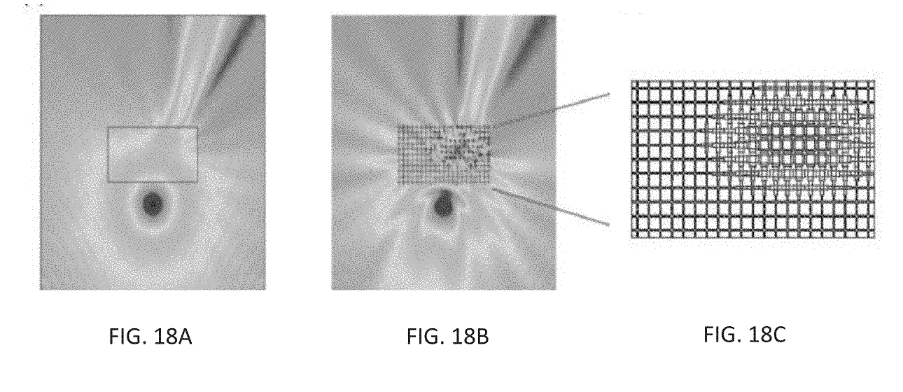

To verify the performance of the design generated by the GRIPP algorithm, the simulated results were compared between an ideal GRIN lens with continuous refractive index profile given by unity impedance, as well as that of a GRIN lens with a real structure consisting of interconnected 3D-cross cells. FIGS. 18A-18C show a top-down view of 3D simulation results. Particularly, FIG. 18A is an image showing an ideal GRIN lens (continuous refractive index and unity impedance), FIG. 18B shows an image of a GRIN lens with real 3D-cross structures (grayscale is scaled to the same as the image in FIG. 18A), and FIG. 18C shows a zoomed-in top-down view of the geometry of the GRIN lens. The control result of the ideal lens is shown in FIG. 18A, where the bended focus can be clearly identified. The result with the structured lens is shown in FIG. 18B (and FIG. 18C is a zoomed-in view of the geometry of the real structure). Excellent agreement is achieved between these two simulations. Minor differences between these two simulated results are likely caused by the non-unity impedance of the unit cells with 3D-cross structures. As shown in Table I of FIG. 17, the impedance of the unit cells become more than 5 when the refractive index goes beyond 1.5. However, the gradient index design has the advantage of smooth transitioning of impedance difference, which essentially acts as an impedance matching network to reduce the undesired scattering caused by the impedance mismatch.

In conclusion, we presented here a computer-aided design tool known as GRIPP algorithm for generating 3D printable gradient index (GRIN) acoustic devices. An expression of the desired three-dimensional refractive index profile and a pre-defined library of unit cells with gradient refractive index are used as the inputs to the GRIPP algorithm, which then scan through the whole spatial grids, pick the unit cell with the best match and place it to the grid point. The final output from the algorithm is a 3D model of the structure that can be directly sent for fabrication.

With its versatility and convenience, GRIPP algorithm would be useful for the rapid design and realization of a large variety of three-dimensional GRIN acoustic devices. The algorithm may be extended to applications in electromagnetics to design 3D antennas and lenses.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. An acoustic imaging system comprising:
a sound forming lens configured to focus sound waves received from a plurality of directions onto respective predetermined areas; and
a plurality of sound amplitude detectors positioned to receive the focused sound waves at the predetermined areas and to output signals indicative of the directions of receipt of the sound waves by the sound forming lens.

2. The acoustic imaging system of claim 1, wherein the sound forming lens comprises a Luneburg lens.

3. The acoustic imaging system of claim 1, wherein the sound forming lens comprises a gradient refractive index (GRIN) device.

4. The acoustic imaging system of claim 3, wherein GRIN device is shaped to have one of substantially spherical symmetry and substantially cylindrical symmetry.

5. The acoustic imaging system of claim 1, wherein the sound forming lenses comprises a plurality of substantially cross-shaped structures that are spaced apart from each other.

6. The acoustic imaging system of claim 5, wherein the structures are arranged as a lattice.

7. The acoustic imaging system of claim 5, wherein the structures each include elongated members that form a substantially cross shape.

8. The acoustic imaging system of claim 7, wherein a width of the elongated members is less than 1 centimeter.

9. The acoustic imaging system of claim 7, wherein a width of the elongated members is less than 1 millimeter.

10. The acoustic imaging system of claim 5, wherein the structures are arranged to form a series of interconnected, self-supporting, three-dimensional, cross-shaped structures.

11. The acoustic imaging system of claim 1, wherein the sound forming lens includes an internal structure that defines sound propagation channels of predetermined cross-sectional area.

12. The acoustic imaging system of claim 1, wherein the sound forming lens is made of substantially the same material throughout.

13. The acoustic imaging system of claim 1, wherein the sound forming lens is made of silicone rubber.

14. The acoustic imaging system of claim 1, wherein the sound forming lens is a metamaterial gradient index lens made of an inhomogeneous structured metamaterial.

15. The acoustic imaging system of claim 14, wherein the metamaterial gradient index lens has a plurality of different structures having different properties for bending the received sound waves to the predetermined areas to provide a sound image for the sound amplitude detectors.

16. The acoustic imaging system of claim 1, wherein the sound waves are received from one of a gas, a solid, or a fluid.

17. The acoustic imaging system of claim 1, wherein the sound amplitude detectors are arranged in an array.

18. The acoustic imaging system of claim 1, wherein the sound amplitude detectors are one of microphones, hydrophones, and vibration detectors.

19. The acoustic imaging system of claim 1, further comprising display equipment operably connected to outputs of the sound amplitude detectors, the display equipment being configured to display a representation of the directions of receipt of the sound waves by the sound forming lens.

20. The acoustic imaging system of claim 19, wherein the display equipment is configured to display a representation of respective amplitudes of the sound waves.

21. The acoustic imaging system of claim 1, further comprising a sound source configured to generate predetermined soundwaves.

22. The acoustic imaging system of claim 21, wherein the received sound waves are the soundwaves generated by the sound source and reflected from an object.

23. The acoustic imaging system of claim 22, wherein the output signals indicate a location of the object.

24. A method of acoustic imaging, the method comprising:
using a sound forming lens to focus sound waves received from a plurality of directions onto respective predetermined areas;
receiving the focused sound waves at a plurality of sound amplitude detectors; and
using the sound amplitude detectors to output signals indicative of the directions of receipt of the sound waves by the sound forming lens.
